(19) United States
(12) Patent Application Publication
(10) Pub. No.: US 2016/0185479 A1
(43) Pub. Date: Jun. 30, 2016

(54) TRAY

(71) Applicant: MARS, INCORPORATED, McLean, VA (US)

(72) Inventor: Gerd Berger, Grefrath (DE)

(73) Assignee: Mars, Incorporated, McLean, VA (US)

(21) Appl. No.: 14/912,061

(22) PCT Filed: Aug. 6, 2014
(86) PCT No.: PCT/EP2014/066868

§ 371 Date: Feb. 12, 2016

(30) Foreign Application Priority Data
Aug. 12, 2013 (DE) 102013108693.4

(51) Int. Cl. B65D 1/28; B65B 7/01; B65B 7/28; A47J 47/02; B65D 85/00

(52) U.S. Cl. CPC B65D 1/28; A47J 47/02; B65D 85/70; B65B 7/28; B65B 7/01

(57) ABSTRACT

The present invention relates to a tray for foodstuffs, comprising, in this order: a first inner polymer layer, a second polymer layer and an outer aluminium layer, wherein the tray has a sealing region on the upper peripheral rim formed at least by the first polymer layer, wherein the tray can be sealed with a lid.

The present invention relates to a tray, especially a tray for holding foodstuffs.

Numerous foodstuffs, such as ready meals or animal food, are sold in aluminium trays. The inside of the tray is typically coated with a plastic material in order to enable it to be sealed. A plastic material used for this purpose must be designed such that no compounds from the plastic material which might be harmful to health or might alter the taste or are disadvantageous in any other way are released into the foodstuffs to be packed.

Food trays made of aluminium are known in the state of the art, where, for example, their inside surfaces are coated thinly with polypropylene.

One problem associated with the use of aluminium trays for food packaging is that the trays can easily be mechanically deformed. During transport of the packaged foodstuffs from the factory to the place of sale or from the place of sale to the consumer, the packaging may suffer unsightly dents, for example because of knocks or other mechanical effects. In this way, the visual impression of the packaged foodstuffs on the shop shelf is drastically impaired.

In order to counter mechanical deformation of this kind, aluminium trays with a large wall thickness of about 150 μm have so far been used, the inside surfaces of which are coated with a polypropylene layer about 30 μm thick. The great thickness of the aluminium walls is intended to prevent the formation of dents and other types of deformation.

A disadvantage here is that large amounts of aluminium are required. The manufacture of aluminium materials, however, requires a great deal of energy and hence involves high manufacturing costs and has a major impact on the environment.

From non-published DE 10 2012 107 720.7 a tray with a first inner polymer layer having a thickness of 200-400 μm, second polymer layer having a thickness of 20-40 μm and an outer aluminium layer having a thickness of 40-80 μm is known. Such a tray has a high resistance to mechanical deformation and uses a low content of aluminium. The known tray has on the upper peripheral rim thereof a sealing region formed by the second polymer layer which projects above the first inner polymer layer in the sealing region.

It is a disadvantage for this structure that the stability of the sealing region is not sufficient, and the closed tray is difficult to open. Further, especially upon opening the tray, dents may easily occur which are unsightly.

It is accordingly one object of the present invention to provide a tray which overcomes the disadvantages of the state of the art. In particular, a tray for foodstuffs shall be provided, which has a stable sealing region for sealing a lid thereon, which can be easily opened. Further, the tray shall exhibit improved resistance to mechanical deformation and shall at the same time be produced in an environmentally friendly manner with lower manufacturing costs.

This problem is solved by a tray comprising, in this order: a first inner polymer layer, a second polymer layer and an outer aluminium layer, wherein the tray has a sealing region on the upper peripheral rim formed at least by the first polymer layer, wherein the tray can be sealed with a lid.

Especially preferred, the thickness of the first inner polymer layer is from 100-1000 μm, preferably 200-600 μm, even preferably 200-400 μm and still preferred in a range of from 250-350 μm.

Especially preferred, the sealing region is formed by the first and second polymer layer as well as the aluminium layer.

The first inner polymer layer and the second polymer layer are separated from one another by an intermediate layer, which is typically created in that the two polymer layers are formed in different, successive operations, for example in that the second polymer layer is formed on the outer aluminium layer in a first operation, and, preferably after the second aluminium layer has cooled, the first inner polymer layer is formed in a second operation. The intermediate layer formed in this way can be observed in a simple manner, such as by cutting the tray perpendicularly to the layers and inspecting the cut surface under a microscope.

According to one aspect of the present invention, a tray is prepared with a second polymer layer having a thickness in the range of 10-40 μm, preferably 20-40 μm, even preferably 25-35 μm.

In addition, the present invention preferably comprises a tray with the outer aluminium layer having a thickness in a range from 20-80 μm, preferably 40-80 μm, even preferably 40-60 μm.

According to yet another aspect, the present invention relates to a tray wherein the first inner polymer layer and/or the second polymer layer comprises polypropylene and/or polyethylene, preferably polypropylene.

In addition, the invention relates particularly preferably to a tray wherein the first inner polymer layer and/or the second polymer layer consists of polypropylene and/or polyethylene, preferably polypropylene.

Furthermore, the invention preferably provides a tray wherein the first inner polymer layer is a layer produced by injection moulding.

In addition, the invention preferably provides a tray wherein the second polymer layer is a layer applied by lamination and/or coextrusion.

The invention also relates to the use of such a tray for holding foodstuffs, especially animal food or ready meals.

It has surprisingly been found that the tray of the invention has a very stable sealing region, so that a lid sealed on the tray can be easily opened and removed, without forming dents or deformations of the tray. The surface of the tray is nearly perfect and absolutely wrinkle-free.

Further, the tray of the invention exhibits unusually great resistance to mechanical deformation and at the same time contains a considerably smaller amount of aluminium compared to the state of the art. In this way, the tray of the invention can surprisingly be manufactured at considerably lower cost and in an environmentally friendly manner.

In particularly preferred embodiment, the first and second polymer layers are not polymer foam materials. Even preferred, the tray consists of a structure of a first inner polymer layer, a second polymer layer and an outer aluminium layer in the thicknesses as given above.

The shape of the tray of the invention is of no particular significance. All suitable and standard shapes of tray for holding, for example, foodstuffs can be used, i.e. with round, rectangular or square cross-sections, for example.

According to the invention, it may be particularly preferable that first of all an aluminium tray of suitable size and shape and with a wall thickness in accordance with the invention is manufactured. On the inside of that tray, a thin polymer film about 20-40 μm thick can be applied by single or double-sided lamination. That polymer layer serves as a sealing medium. The sealing rim produced in this way is stable, even though there are only relatively thin PP and aluminium layers present.

A second polymer layer, which in accordance with the invention can advantageously be obtained by injection moulding processes, is applied to the thin polymer layer, which is applied directly onto the aluminium. This thicker polymer layer can advantageously be manufactured in a separate process step by injection moulding, in that the aluminium tray, with the second polymer layer applied, is placed in the injection moulding mould, in order for the thicker polymer layer to be produced in the injection moulding machine/the mould.

According to the invention, it may further be contemplated that the thicker first inner polymer layer is also used in the sealing region, but only fills out the interior of the tray body. “Sealing region” here means the region by which a connection to a lid or cover can be made in an appropriate manner. A thin aluminium foil, for example, which is fused with the sealing region of the food tray, can serve as a cover.

In addition to the methods of producing the polymer layers explicitly mentioned (single or double-sided lamination, injection moulding), any other suitable method known in the state of the art for producing polymer layers can also be used in accordance with the invention.

The first inner polymer layer and the second polymer layer may have different chemical compositions and may accordingly differ in their chemical and physical properties. It is however, likewise contemplated in accordance with the invention that the two polymer layers have the same or a similar chemical structure and accordingly have substantially the same or similar chemical and physical properties.

Further features and advantages of the tray of the invention will become clear from the following detailed description of a preferred embodiment, with reference to the Figures, where

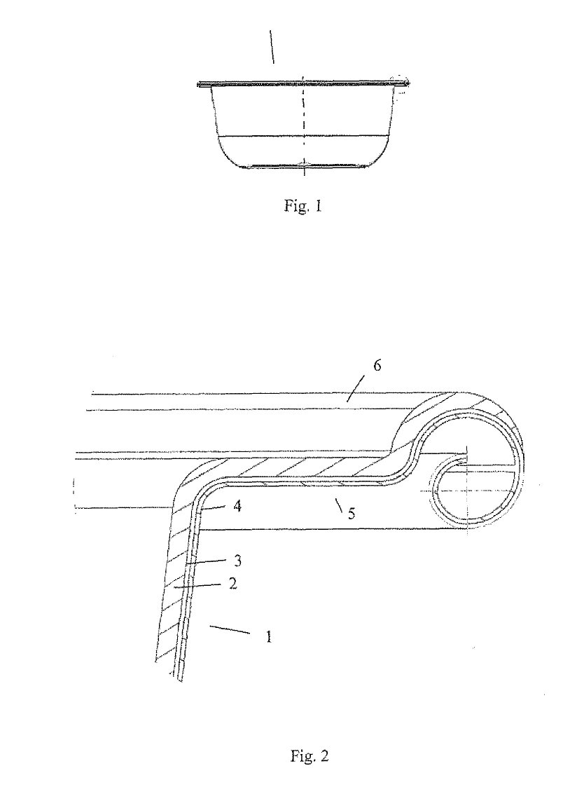

FIG. 1 is a cross-section of a tray in accordance with the invention; and

FIG. 2 is an enlarged partial view of the cross-section of FIG. 1, especially of the upper part of the tray comprising the sealing region.

Referring to FIGS. 1 and 2, the tray of the invention will be explained in the following, taking a preferred embodiment as an example.

FIG. 1 is a schematic view of the complete cross-section of a tray in accordance with the invention 1. FIG. 2 shows a detail of the cross-section of the tray 1 enlarged on a scale of 20:1, which is marked with a circle in the upper right-hand corner of FIG. 1. The tray comprises a first inner polymer layer 2, a second polymer layer 3 and an outer aluminium layer 4. FIG. 2 likewise shows a schematic view of a lid 6 and a sealing region 5, which comprises the outer aluminium layer 4, the first polymer layer 2 and the second polymer layer 3. The lid 6 is applied on the sealing region 5 and is sealed thereon.

The features of the invention disclosed in the above description and in the claims and drawing can be essential to implementing the invention in its various embodiments both individually and in any combination.

1. A tray comprising, in this order: a first inner polymer layer, a second polymer layer and an outer aluminium aluminum layer, wherein the tray has a sealing region on the upper peripheral rim formed at least by the first polymer layer, wherein the tray is configured to have a lid sealed to the sealing region.

2. The tray as claimed in claim 1, wherein the first inner polymer layer has a thickness in a range from 100-1000 μm.

3. The tray as claimed in claim 1, wherein the second polymer layer has a thickness in a range from 10-40 μm.

4. The tray as claimed in claim 1, wherein the outer aluminum layer has a thickness in a range from 20-80 μm.

5. The tray as claimed in claim 1, wherein the first inner polymer layer and the second polymer layer includes at least one of polypropylene and polyethylene.

6. (canceled)

7. (canceled)

8. The tray as claimed in claim 1, comprising: foodstuffs enclosed in the tray by the lid.

9. A method of forming a tray, the method comprising:
forming a laminate structure having a shape defining an internal cavity and a sealing region about a periphery of the internal cavity, the laminate structure including an aluminum layer and a first polymer layer on an inside facing surface of the aluminum layer;
placing the laminate structure in a mold; and
injecting a polymer into the mold such that the polymer forms a second polymer layer on an inside facing surface of the first polymer layer and on the first polymer layer in the sealing region.

10. The method as claimed in claim 9, wherein forming the laminate structure includes either laminating the first polymer layer onto the aluminum layer or coextruding the aluminum layer and the first polymer layer.

11. The method as claimed in claim 9, comprising:
placing a foodstuff in the internal cavity; and
sealing a lid to the second polymer layer in the sealing region.

12. The method as claimed in claim 9, wherein the aluminum layer has a thickness in a range of 20-80 μm,
wherein the first polymer layer has a thickness in a range of 20-80 μm,
wherein the second polymer layer has a thickness in a range of 100-1000 μm.

13. The method as claimed in claim 9, wherein the first polymer layer and the second polymer layer include at least one of polypropylene and polyethylene.

14. A tray comprising:
a multi-layer structure defining a product cavity and a sealing region about a periphery of the product cavity, the multi-layer structure including:
an aluminum layer;
a first polymer layer attached to the aluminum layer; and
a second polymer layer attached to the first polymer layer about the entire mating surfaces therebetween, the second polymer layer having an internal surface which defines the product cavity, wherein the second polymer layer extends into the sealing region; and
a lid enclosing the product cavity, the lid attached to the sealing region of the multi-layer structure.

15. The tray as claimed in claim 14, comprising:
a foodstuff disposed in the product cavity.

16. The tray as claimed in claim 15, wherein the foodstuff is animal food.

17. The tray as claimed in claim 14, wherein the multi-layer structure defines a curl outside of the sealing region,
wherein the second polymer layer extends through the sealing region and partially around the curl.

18. The tray as claimed in claim 14, wherein the second polymer layer has a thickness in a range of 100-1000 μm.

19. The tray as claimed in claim 14, wherein the first polymer layer has a thickness in a range of 10-40 μm.

20. The tray as claimed in claim 14, wherein the aluminum layer has a thickness in a range of 20-80 μm.

21. The tray as claimed in claim 14, wherein the aluminum layer has a thickness in a range of 60-80 μm,
wherein the first polymer layer has a thickness in a range of 25-35 μm,
wherein the second polymer layer has a thickness in a range of 250-350 μm.

22. The tray as claimed in claim 14, wherein the first polymer layer and the second polymer layer include at least one of polypropylene and polyethylene.
